(19) United States
(12) Patent Application Publication
(10) Pub. No.: US 2014/0299546 A1
(43) Pub. Date: Oct. 9, 2014

(54) NANOFILTRATION PROCESS FOR ENHANCED BRINE RECOVERY AND SULFATE REMOVAL

(71) Applicant: Chemetics Inc., (US)

(72) Inventors: Norbert Eckert, West Vancouver (CA); Thomas Drackett, North Vancouver (CA); Ian Bailey, Vancouver (CA); Allison Merz, Vancouver (CA); Felix Mok, Vancouver (CA); Siamak Lashkari, Vancouver (CA); Ganapathy Ramasubbu, Delta (CA)

(21) Appl. No.: 13/856,998

(22) Filed: Apr. 4, 2013

(51) Int. Cl. B01D 61/10; B01D 61/02

(52) U.S. Cl. CPC B01D 61/10; B01D 61/027; B01D 61/022
USPC 210/651; 210/198.1; 210/201; 210/205

(57) ABSTRACT

In a nanofiltration system for removing sulfate impurity from an aqueous brine stream and for recovering the brine, introducing a dilution stream upstream of the feed stream inlet of a nanofiltration module in the system dilutes the feed stream. This increases the amount of brine salt and water obtained in the permeate stream without substantially diluting the concentration of sulfate in the pass stream and hence results in enhanced recovery of brine while efficiently removing sulfate impurity. The system and process is especially suitable for recovering brine and removing sulfate impurity from a brine stream in a brine electrolysis plant. In a conventional system, the heat exchanger typically used to cool the feed stream can be omitted if the dilution stream is provided at a temperature suitably lower than that of the feed stream.

### BACKGROUND

1. Technical Field

The present invention pertains to nanofiltration processes and systems for recovering brine and for removing sulfate impurity from a brine stream in the industrial processing of chemicals. In particular, it pertains to nanofiltration of brine streams in brine electrolysis processing.

2. Description of the Related Art

Pressure driven membrane separation processes are known wherein organic molecules or inorganic ionic solutes in aqueous solutions are concentrated or separated to various degrees by the application of a positive osmotic pressure to one side of a filtration membrane. Examples of such processes are reverse osmosis (RO), ultrafiltration (UF) and nanofiltration (NF). These pressure driven membrane processes employ a cross-flow mode of operation wherein only a portion of a feed stream solution is collected as a permeate solution and the rest is collected as a pass solution. Thus, in a nanofiltration module, the exiting process stream which has not passed through the nanofiltration membrane is referred to as the “pass stream” and the exiting process stream which has passed through the membrane is referred to as the “permeate” stream.

NF membranes are structurally similar to RO membranes in that chemically they typically are crosslinked aromatic polyamides, which are cast as a thin “skin layer” on top of a microporous polymer sheet support to form a composite membrane structure. The separation properties of the membrane are controlled by the pore size and electrical charge of the “skin layer”. Such a membrane structure is usually referred to as a thin film composite (TFC). However, unlike RO membranes, the NF membranes are characterized in having a larger pore size in its “skin layer” and a net negative electrical charge inside the individual pores. This negative charge is responsible for rejection of anionic species, according to the anion surface charge density. Accordingly, divalent anions, such as SO₄²⁻, are more strongly rejected than monovalent ones, such as Cl⁻. And therefore, nanofiltration can be particularly suitable for processes requiring separation of divalent anions from monovalent anions.

Commercial NF membranes are available from known suppliers of RO and other pressure driven membranes. The NF membranes are, typically, packaged as membrane modules. A so-called “spiral wound” module is most popular, but other membrane module configurations, such as tubular membranes enclosed in a shell or plate-and-frame type, are also known.

During the NF process, a minimum pressure equal to the osmotic pressure difference between the feed/pass liquor on one side and the permeate liquor on the other side of the membrane must be applied since osmotic pressure is a function of the ionic strengths of the two streams. In the case of separation of a multivalent solute, such as Na₂SO₄, from a monovalent solute, such as NaCl, the osmotic pressure difference is moderated by the low NaCl rejection. Usually, a pressure in excess of the osmotic pressure difference is employed to achieve practical permeate flux.

Industrial brine electrolysis processing plants (e.g., chloralkali or chlorate plants) may advantageously use nanofiltration in certain of the processing steps, and particularly in the removal of sulfate from the brine streams employed. Various products are produced using brine as the starting material. For instance, sodium chlorate is generally prepared by the electrolysis of sodium chloride brine to produce chlorine, sodium hydroxide and hydrogen. The chlorine and sodium hydroxide are immediately reacted to form sodium hypochlorite, which is then converted to chlorate and chloride under controlled conditions of pH and temperature. Alternatively, chlorine and caustic soda are prepared by electrolysis of sodium chloride brine in an electrolytic cell or electrolyser, which contains a membrane to prevent chlorine and caustic soda reacting.

However, the sodium chloride salt used to prepare the brine for electrolysis generally contains impurities which, depending on the nature of the impurity and production techniques employed, can give rise to plant operational problems familiar to those skilled in the art. While the means of controlling these impurities are varied, they include purging them out of the system into alternative processes or to the drain, precipitation by conversion to insoluble salts, and/or crystallization or ion exchange treatment. Further, control of anionic impurities presents more complex problems than that of cationic impurities.

Sulfate ion (also referred to herein as sulfate) is a common impurity in commercial salt and, being an anion, is a more complex impurity to deal with. When such salt is used directly, or in the form of a brine solution, and specific steps are not taken to remove the sulfate, the sulfate enters the electrolytic system. Sulfate ion maintains its identity under the conditions in the electrolytic system and, thus, accumulates and progressively increases in concentration in the system unless removed in some manner. In chlorate plants producing a liquor product, the sulfate ion will leave with the product liquor. In plants producing only crystalline chlorate, the sulfate remains in the mother liquor after the crystallization of the chlorate, and is recycled to the cells. Over time, the concentration of sulfate ion will increase and adversely affect electrolysis and cause operational problems due to localized precipitation in the electrolytic cells. Within the chloralkali circuit, the sodium sulfate will concentrate and adversely effect the membrane, which divides the anolyte (brine) from the catholyte (caustic soda). It is industrially desirable that sodium sulfate levels in concentrated brine (e.g., 300 g/L NaCl) be reduced to at least 20 g/L in chlorate production and about 10 g/L in chloralkali production.

Some years ago, it was found that NF membranes showed unexpected ion membrane selectivity at relatively high salt concentrations and this offered attractive applications in the treatment of brine electrolysis liquors having sodium sulfate levels unacceptable in recycle systems. U.S. Pat. No. 5,587,083 and U.S. Pat. No. 5,858,240 disclosed use of nanofiltration systems in the application of sulfate removal from spent electrolysis brine. When using these nanofiltration processes, because there was no buildup in concentration of sodium chloride in the pass liquor stream over its original level in the feed stream, it was possible to increase the content of sodium sulfate in the pass liquor to a higher level than would have been possible if the NaCl level of the pass liquor has increased. It was now possible to realize a desirable high % recovery and, in the case of electrolysis brine, to minimize the volume of brine purge, and/or the size of a reactor and the amount of chemicals for an, optional, subsequent sulfate precipitation step.

For certain reasons, various modifications have been proposed. For instance, US2008/0056981 discloses a method for at least partially removing soluble divalent anions from an aqueous divalent anion-containing brine solution comprising a crystal growth inhibitor (CGI) for the divalent anion. The method comprises the process steps: obtaining a sodium chloride concentration between 100 g/L and saturation in the presence or absence of a CGI for sodium chloride or a sodium chloride concentration above saturation in the presence of a CGI for sodium chloride, and acidifying the solution to a pH below 11.5; subjecting the solution to a membrane filtration step thereby separating the brine solution into a brine stream being supersaturated for the divalent anion (concentrate), and a brine stream being undersaturated for the divalent anion (permeate); subjecting the supersaturated brine stream comprising the crystal growth inhibitor for the divalent anion to a crystallization process, removing crystallized divalent anion; and optionally, recycling the overflow of the crystallizer to the brine solution for subjecting it again to the membrane filtration step.

Nanofiltration techniques have also been suggested for use in completely different industrial processes. For instance, U.S. Pat. No. 7,314,606 discloses a process for recovering sodium thiocyanate and separating impurities from industrial process solutions comprising sodium thiocyanate using nanofiltration techniques.

There still remains, however, a need for ever greater efficiency in the sulfate removal process and for recovery of useful brine from brine streams in industrial chemical processing settings, and particularly from spent brine streams in brine electrolysis processing.

### BRIEF SUMMARY

The present invention provides for desirable sulfate removal from process brine streams while recovering more of the brine salt for reprocessing. In brine electrolysis processing, this can result in substantial savings of valuable raw material and reduction in waste. Further, in some brine electrolysis plants, pure water is itself a valuable raw material that must be provided as an input. In such plants, the present invention can also provide for greater recovery of water which meets the purity requirements for the process. And further still, the brine streams in typical brine electrolysis plants often contain sodium chlorate and/or bromate which are also therefore present to some extent in the effluent sulfate stream. However, there are increasingly restrictive environmental limits on chlorate and bromate in effluent streams. Advantageously, the present invention also results in a reduction of these species in the effluent sulfate stream.

Specifically, a process and system are provided for recovering brine and for removing sulfate impurity from a brine stream in a nanofiltration system. The brine stream here comprises an aqueous solution of NaCl, and the system comprises a nanofiltration module. The nanofiltration module comprises a nanofiltration membrane for rejecting sulfate, an inlet for a feed stream, an outlet for a permeate stream which has permeated through the membrane, and an outlet for a pass stream which has not permeated through the membrane. The nanofiltration membrane may be any of those conventional membranes suitable for rejecting sulfate. A dilution stream is introduced upstream of the feed stream inlet of the module, and thereby dilutes the feed stream at the feed inlet of the module and increases the amount of NaCl and water in the permeate stream at the permeate outlet of the module without substantially diluting the concentration of sulfate in the pass stream at the pass outlet of the module. And so, albeit more diluted, there is more brine salt present in total in the permeate stream which can be recovered. Of further advantage is that more water of sufficient purity for use in the brine electrolysis process can also be recovered. The rejected pass stream on the other hand has a much reduced concentration of brine salt while roughly maintaining the same concentration of sulfate.

The brine stream may comprise additional species such as NaClO₃ and/or NaBrO₃, which can also be present in the effluent rejected pass stream. Introducing a dilution stream in accordance with the invention also reduces the concentration of chlorate and/or bromate in the effluent pass stream and thus offers environmental advantages as well. Instead, an increased amount of chlorate and/or bromate is returned in the volume of permeate.

The dilution stream can desirably be water or any suitable, compatible liquid, such as a very dilute brine. (Depending on the processing and systems involved, very dilute brine streams may possibly be derived from elsewhere in a specific plant.) An additional advantage of diluting the feed brine stream is that a more neutral, desirable stream pH (i.e., pH from about 5 to 9) can be obtained.

A preferred nanofiltration system may be a multi-stage system comprising at least a first nanofiltration module and a second nanofiltration module in series. A greater number of nanofiltration modules in series may be contemplated depending on the specific circumstances. Each module in the system may comprise a nanofiltration membrane for rejecting sulfate, a feed stream inlet, a permeate stream outlet, and a pass stream outlet, wherein the pass stream outlet of the first module is connected to the feed stream inlet of the second module.

Introducing the dilution stream between the pass stream outlet of the first module and the feed stream inlet of the second module in such a series arrangement allows for more efficient use of the volume of the dilution stream. Desirable results can be obtained for instance for a volumetric flow rate ratio of the total dilution streams to that of the brine stream of less than or about 12:70. And with a sufficient number of module and dilution stream stages in series, the brine and other content in the process pass stream may be reduced enough to purify the sulfate in the pass stream to a commercial grade and thus become a valuable by-product as opposed to a waste.

As demonstrated in the following Examples, an upstream brine stream comprising greater than or about 200 g/L NaCl and less than about 10 g/L Na₂SO₄ can be subjected to the nanofiltration process to produce a pass stream comprising less than or about 50 g/L NaCl and greater than about 50 g/L Na₂SO₄.

The nanofiltration system may be particularly employed to remove sulfate impurity and recover substantial brine from the spent brine stream or product liquor coming from the electrolysers used in industrial brine electrolysis chemical processing. A related brine electrolysis plant, such as a chloralkali or chlorate plant, can thus comprise an electrolyser and the nanofiltration system in which the spent brine outlet of the electrolyser is connected to the feed stream inlet of the nanofiltration module.

In a brine electrolysis chemical processing plant in which an initial NaCl brine is prepared in a saturator from a concentrated supply of salt (e.g., crystalline salt), a spent brine stream from an electrolyser may be fed to the nanofiltration system of the invention and the permeate stream recycled directly to the saturator. In a brine electrolysis chemical processing plant in which crystalline salt is not a salt source (e.g., well brine as the salt source), the spent brine stream may first need to be concentrated in an evaporator (which concentrates both the NaCl brine salt and the sulfate in the stream). Sulfate impurity may then be removed by feeding a portion of the now-concentrated spent brine stream to the nanofiltration system, recycling the permeate stream to the evaporator, and rejecting the sulfate-containing pass stream. In a further embodiment, the nanofiltration system of the invention may be employed upstream of an electrolyser in a brine electrolysis chemical processing plant, that is wherein the brine inlet of the electrolyser is connected to the permeate stream outlet of the nanofiltration module.

In certain embodiments, the dilution stream can be introduced at a temperature substantially lower than that of the upstream brine stream. If the dilution stream is introduced in a sufficient amount at a sufficiently low temperature, a heat exchanger for cooling the upstream brine stream may not be required. The system may thus be absent the heat exchanger which may be employed for cooling the upstream brine stream in conventional systems.

### BRIEF DESCRIPTION OF THE DRAWINGS

FIG. 1 shows a simplified schematic of an industrial chloralkali plant of the prior art comprising an electrolyser and a nanofiltration sulfate removal system.

FIG. 2 shows a simplified schematic of a multi-stage sulfate removal system of the prior art comprising multiple nanofiltration membrane modules in series and an upstream heat exchanger.

FIG. 3 shows a simplified schematic of a representative multi-stage sulfate removal system of the invention comprising multiple nanofiltration membrane modules in series and conduits for introducing dilution water.

FIG. 4 shows a simplified schematic of the modeled multi-stage sulfate removal system of the Examples comprising three nanofiltration membrane modules in series and two conduits for introducing dilution water.

FIG. 5 shows the same modeled multi-stage sulfate removal system as FIG. 4 except without any conduits for introducing dilution water.

### DETAILED DESCRIPTION

Unless the context requires otherwise, throughout this specification and claims, the words “comprise”, “comprising” and the like are to be construed in an open, inclusive sense. The words “a”, “an”, and the like are to be considered as meaning at least one and not limited to just one. Further, in a numerical context, the word “about” is to be construed as meaning plus or minus 10%.

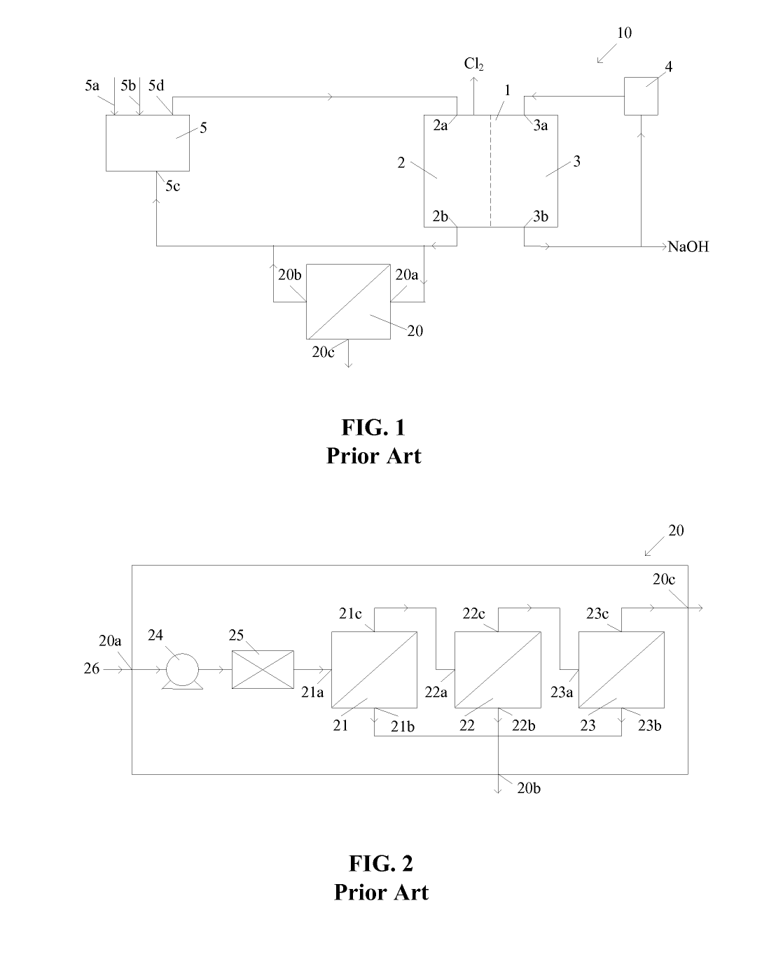

An exemplary industrial brine electrolysis plant is a chloralkali plant. Such plants are commonly found throughout the world. A simplified schematic for a prior art chloralkali plant 10 is shown in FIG. 1. In the process depicted here, NaCl based brine undergoes electrolysis in electrolyser 1 to produce primary products chlorine gas at anode 2 and NaOH and hydrogen gas at cathode 3. Other products can then be obtained as a result of an additional series of reactions between the primary products. For instance, sodium chlorate product, NaClO₃, can be obtained by allowing the chlorine and NaOH caustic to intermix under appropriate controlled conditions. In plant 10, catholyte is provided to cathode inlet 3a of electrolyser 1 from catholyte tank 4. Spent catholyte is withdrawn from cathode outlet 3b and one portion is recycled back to catholyte tank 4 while another portion is removed to obtain a supply of product (e.g., NaOH caustic product). Anolyte brine is prepared in saturator 5 and then provided from saturator outlet 5d to anode inlet 2a of electrolyser 1. Spent anolyte is withdrawn from anode outlet 2b and is recycled back to saturator 5 at recycle inlet 5c for reuse. The appropriate concentration of NaCl brine for the electrolysis process is maintained by adding the right amounts of process solid crystalline salt and process water at saturator inlets 5a and 5b respectively.

As mentioned previously, sodium sulfate impurity (typically appearing in the process salt provided) undesirably increases in concentration in the recycling anolyte unless it is continually removed. In the chloralkali plant of FIG. 1, nanofiltration system 20 is provided for that purpose as a branch loop in the recycling anolyte line between anode outlet 2b and saturator recycle inlet 5c. Sulfate is continually removed from the circulating anolyte stream by directing a portion of the spent anolyte to feed 20a of nanofiltration system 20. Purified brine permeate is returned to the circulating anolyte from permeate outlet 20b and a reject stream concentrated in sulfate is removed from circulation at pass outlet 20c. (Note that many other components and/or subsystems, such as pumps, heat exchangers, control subsystems, are typically employed in an industrial chloralkali plant like that shown in FIG. 1, but these have been omitted for simplicity.)

FIG. 2 shows a more detailed schematic of a prior art multi-stage nanofiltration system that might be used to purify spent anolyte brine by removing sodium sulfate in the chloralkali plant of FIG. 1. Here, nanofiltration system 20 is shown as comprising several (three) nanofiltration membrane modules 21, 22, 23 connected in series. (As known to those of skill in the art, the number of modules employed in series may vary from situation to situation. And further, modules may be employed in parallel arrangements as well in order to handle situations involving larger volumes.) Process (spent anolyte) brine stream 26 is provided to system feed inlet 20a and directed to high pressure pump 24 which boosts the brine stream pressure to a value suitable for nanofiltration. In typical applications, the temperature of the provided and/or boosted brine stream is however undesirably high. Thus, heat exchanger 25 is used to lower the temperature to an appropriate level for nanofiltration. Then the pressure-boosted, cooled brine stream is supplied to the series of nanofiltration modules at feed inlet 21a of the first nanofiltration module 21.

Series modules 21, 22, and 23 comprise nanofiltration membranes suitable for rejecting sulfate, for instance single spiral wound type nanofiltration units. Modules 21, 22, 23 comprise feed stream inlets 21a, 22a, 23a, permeate stream outlets 21b, 22b, 23b and pass stream outlets 21c, 22c, and 23c respectively. The modules are connected in series by connecting the pass stream outlet from an upstream module to the feed stream inlet of the adjacent module downstream (e.g., pass stream outlet 21c is connected to feed stream inlet 22a). Process anolyte brine 26 comprising NaCl brine salt and Na₂SO₄ impurity is thus concentrated in sulfate in stages in the pass streams from the nanofiltration modules while the brine salt concentration in both the pass streams and the permeate streams is only slightly reduced. The pass stream from final module 23 in the series is rejected at system pass outlet 20c. The several permeate streams from outlets 21b, 22b, and 23b may be combined into a single resultant purified brine stream which is directed back to the recycle brine line from output 20b. (Again, not shown in simplified FIG. 2 are components such as pressure control valves, sensors, and other hardware which are typically provided for process control as is known to those skilled in the art.)

While nanofiltration systems such as that shown in FIG. 2 have served the brine electrolysis industry well for many years, there is ever growing demand to conserve resources, increase process efficiency, and minimize effluents in these large industrial systems. The nanofiltration processes and systems of the invention allow for greater recovery of precious electrolysis grade brine salt and for improvements in process efficiency.

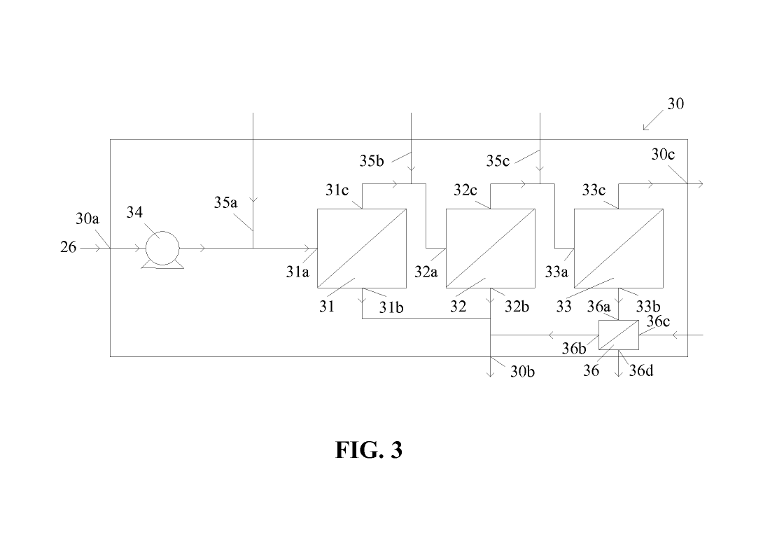

FIG. 3 shows a schematic of an improved multi-stage nanofiltration system of the invention suitable for use in the chloralkali plant of FIG. 1. In a like manner to the system in FIG. 2, the system of FIG. 3 comprises high pressure pump 34 to boost the pressure of brine stream 26 suitable for nanofiltration. And nanofiltration modules 31, 32, and 33 are provided in series purify the brine stream and remove sulfate impurity therefrom. As before, process (spent anolyte) brine stream 26 is provided to system feed inlet 30a, its pressure is boosted by pump 34 and the pressure-boosted brine stream is supplied to the series of nanofiltration modules at feed inlet 31a of the first nanofiltration module 31.

Modules 31, 32, 33 comprise feed stream inlets 31a, 32a, 33a, permeate stream outlets 31b, 32b, 33b and pass stream outlets 31c, 32c, and 33c respectively. Again, the modules are connected in series by connecting the pass stream outlet from an upstream module to the feed stream inlet of the adjacent module downstream (e.g., pass stream outlet 31c is connected to feed stream inlet 32a).

In the embodiment of FIG. 3 however, a dilution stream or streams is provided at one or more inlets to modules 31, 32, and 33 to desirably increase the recovery of brine salt. As illustrated in FIG. 3, a dilution stream can be introduced at one or more of locations 35a, 35b, or 35c. The dilution stream can desirably be water or any suitable, compatible liquid, such as a very dilute brine. Consequently there is an initial reduction in concentration of all species in the diluted feed stream. Further, there is a dilution in all the species that permeate through the module membrane and hence in the respective permeate. And there is a similar reduction in concentration of monovalent species in the respective pass streams (e.g., in [NaCl], [NaClO₃], and [NaBrO₃]). The concentrations of sulfate however in the respective pass streams are not significantly changed from that obtained in the embodiment of FIG. 2 operating under similar conditions. Thus, the nanofiltration system of FIG. 3 outputs a reject pass stream at outlet 30c with a similar concentration of sulfate as the system of FIG. 2, but with a much reduced concentration of brine, chlorate, bromate, and any other monovalent species. And so, the system of FIG. 3 retains more total brine, chlorate, and bromate in the permeate streams from module permeate outlets 31b, 32b, and 33b than does the system of FIG. 2, albeit diluted to a lower concentration.

Although an objective of increased brine recovery can be obtained by introducing a dilution stream at any of the locations indicated, introducing the dilution stream after the first module in the series (i.e., at 35b between the pass stream outlet of the first module and the feed stream inlet of the second module, or for instance at 35c) allows for more efficient use of the volume of the dilution stream. As illustrated in the following Examples, desirable results can be obtained for example in a system comprising three nanofiltration modules in series and employing two such dilutions for a volumetric flow rate ratio of the total dilution streams to that of the brine stream of less than or about 12:70.

Preferably the volume of fluid making up the dilution stream is obtained from elsewhere in the overall chloralkali plant 10. In this way, little or no additional process fluid needs to be provided to the system overall. For instance, in the industrial chloralkali plant of FIG. 1, water for a dilution stream may be obtained from the process water otherwise provided at inlet 5b of saturator 5. Since much of this water is recycled back to saturator 5 after filtration anyway, the requirements for additional process fluid can be markedly reduced and perhaps even eliminated. Depending on the specifics of the brine electrolysis plant involved, those skilled in the art will appreciate that water or other fluids such as very dilute brine may be obtained from elsewhere in the system for use as a source of volume for a dilution stream.

The present approach can offer other advantages along with the recovery of brine salt and efficiency. Introducing a dilution stream can be generally advantageous in that the brine stream feed to a given nanofiltration module is at a more desirable stream pH.

Further, the pass stream comprising the rejected concentrated sulfate is often considered a waste product that may be discharged to sewer. However, with a sufficient number of module and dilution stream stages in series, the brine and other content in the process pass stream may be reduced enough to purify the sulfate in the pass stream to that of commercial grade for industrial purposes and thus become a valuable by-product instead of a waste.

Still further, if water or other dilution stream volume is available in a sufficient amount at a sufficiently low temperature, the heat exchanger often employed in conventional sulfate removal systems (e.g., heat exchanger 25 in FIG. 2) may no longer be required. In this case, the dilution stream being introduced at a temperature substantially lower than that of the upstream brine stream, allows for the system to be absent the heat exchanger employed for cooling the upstream brine stream in such conventional systems. FIG. 3 illustrates such an embodiment absent a heat exchanger.

As in prior art systems, the several permeate streams from outlets 31b, 32b, and 33b in FIG. 3 may be combined into a single resultant purified, but more diluted, brine stream which is directed back to the recycle brine line. It may however be desirable to re-concentrate a permeate stream or combination of permeate streams prior to recycling it back to the recycle brine line. FIG. 3 illustrates an optional arrangement for re-concentrating just the permeate stream from module 33 prior to combining with the permeate streams from modules 31 and 32. Here, permeate from permeate outlet 33b is directed first to inlet 36a of osmotic membrane distillation module 36 where it is concentrated and output from outlet 36b to then be combined with the other permeate streams from modules 31 and 32. The process of osmotic membrane distillation (for instance as discussed in U.S. Pat. No. 7,361,276) requires the provision of a more concentrated receiver solution to the other side of the membrane in osmotic membrane distillation module 36 in order to drive the process. In FIG. 3, an appropriate receiver stream is thus to be provided at receiver stream inlet 36c and is removed at receiver stream outlet 36d.

The preceding discusses a chloralkali chemical processing plant in which the initial process brine is prepared in a saturator and the permeate stream from the nanofiltration system is recycled directly to the saturator. However, another conventional configuration for the preceding chloralkali process (not shown) uses well brine as the initial brine supply as opposed to concentrated crystal brine. In this alternative conventional process, the spent anolyte stream leaving the electrolyser needs to be concentrated in order to be recycled since there is no crystalline salt supply available to mix therewith. In this system then, an evaporator subsystem is typically employed to concentrate the spent anolyte brine stream and this will obviously concentrate any Na₂SO₄ present in the stream as well. It may be desirable then to employ a nanofiltration system of the invention in the evaporator subsystem instead in order to remove sulfate from the stream.

The following Examples have been included to illustrate certain aspects of the invention but should not be construed as limiting in any way. Those skilled in the art can be expected to appreciate how to modify the nanofiltration system and process according to the specifics of a given industrial application for brine recovery and sulfate removal.

### EXAMPLES

Calculated models were obtained for purposes of comparing the characteristics expected of an exemplary nanofiltration system in which two dilution streams were introduced in accordance with the invention to those expected of the same nanofiltration system but without dilution streams (i.e., a conventional system). In both cases, it was assumed that the systems were provided with a spent brine stream composition from a typical chloralkali electrolysis plant. This brine stream contained 200 g/L NaCl and 10 g/L Na₂SO₄ and was supplied at a flow rate of 70 m³/hr, a temperature of 75° C., and a pressure of 40 bar.

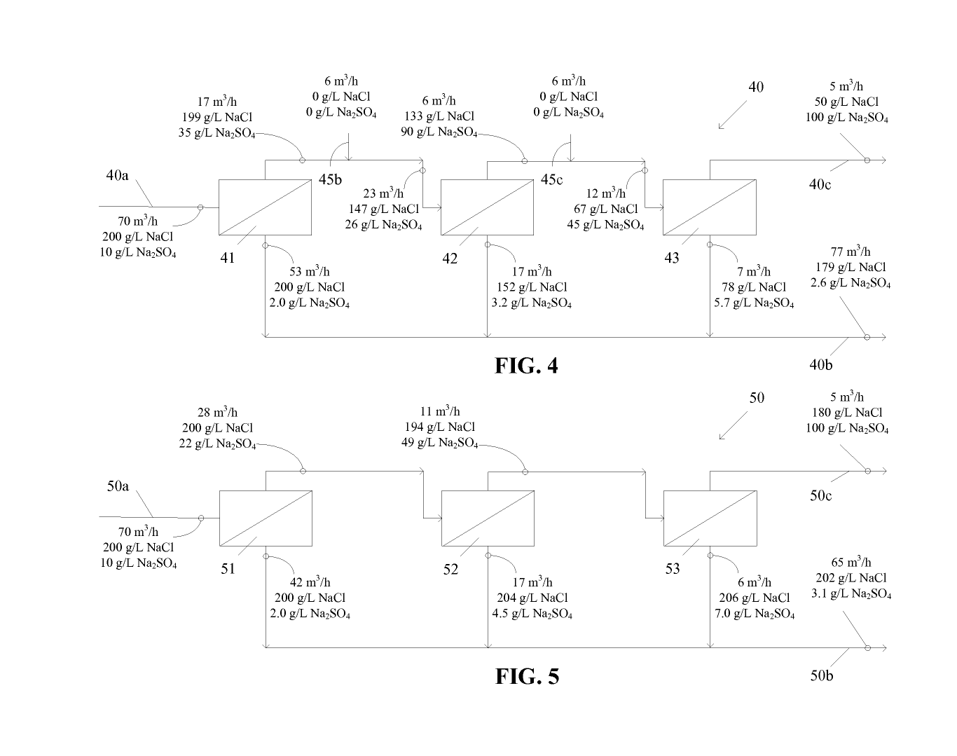

The modeled nanofiltration system 40 comprised three nanofiltration modules 41, 42, 43 in series as depicted in FIG. 4. The modules were assumed to comprise a nanofiltration filtration selected for this application. In the modeling, spent brine stream 40a was supplied initially to module 41. Two dilution streams comprising pure (i.e., demineralised) water were introduced at locations 45b and 45c into the feed inlets of nanofiltration modules 42 and 43 respectively as depicted in FIG. 4. Both dilution streams were introduced at flow rates of 6 m³/hr, temperatures of 75° C., and pressures of 40 bar. The ratio of total dilution water volume supplied to that of the spent brine stream was thus 12:70.

The calculated flow rates and concentrations of the involved species at various locations throughout system 40 are given on FIG. 4. In particular, the net combined system permeate stream at system permeate outlet 40b contained 179 g/L NaCl and 2.6 g/L Na₂SO₄ at a flow rate of 77 m³/hr. The final system pass stream at system pass outlet 40c contained 50 g/L NaCl and 100 g/L Na₂SO₄ at a flow rate of 5 m³/hr.

The same calculations were then performed on a system similar to that of FIG. 4 being supplied with the same spent brine stream 50a but without introducing any dilution streams. In this case, the calculated flow rates and concentrations of the involved species at various locations throughout this conventional system 50 (comprising three nanofiltration modules 51, 52, 53 in series) are given on FIG. 5. In particular, the net combined system permeate stream at system permeate outlet 50b contained 202 g/L NaCl and 3.1 g/L Na₂SO₄ at a flow rate of 65 m³/hr. The final system pass stream at system pass outlet 50c contained 180 g/L NaCl and 100 g/L Na₂SO₄ at a flow rate of 5 m³/hr. (Note that the absence of a dilution stream being introduced at location 45b has an effect on what takes place in first module 51 and hence on the flow rates and compositions of the permeate and pass streams coming from module 51.)

As is evident from the models in FIGS. 4 and 5, employing dilution streams in accordance with the invention markedly reduces the loss of NaCl in the final pass stream of the system. Qualitatively, a similar reduction would be expected for NaClO₃ or NaBrO₃ species if these were present in spent brine stream 40a.

All of the above U.S. patents, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. Such modifications are to be considered within the purview and scope of the claims appended hereto.

1. A process for recovering brine and for removing sulfate impurity from a brine stream in a nanofiltration system, the brine stream comprising an aqueous solution of NaCl, the system comprising a nanofiltration module, the module comprising a nanofiltration membrane for rejecting sulfate, an inlet for a feed stream, an outlet for a permeate stream which has permeated through the membrane, and an outlet for a pass stream which has not permeated through the membrane, the process comprising:
introducing a dilution stream upstream of the feed stream inlet of the module, thereby diluting the feed stream at the feed inlet of the module and increasing the amount of NaCl and water in the permeate stream at the permeate outlet of the module without substantially diluting the concentration of sulfate in the pass stream at the pass outlet of the module.

2. The process of claim 1 wherein the brine stream additionally comprises NaClO₃ or NaBrO₃.

3. The process of claim 1 wherein the dilution stream is water or a dilute brine.

4. The process of claim 1 wherein the nanofiltration system is a multi-stage system comprising at least a first nanofiltration module and a second nanofiltration module in series, each module comprising a nanofiltration membrane for rejecting sulfate, a feed stream inlet, a permeate stream outlet, and a pass stream outlet, wherein the pass stream outlet of the first module is connected to the feed stream inlet of the second module.

5. The process of claim 4 comprising introducing the dilution stream between the pass stream outlet of the first module and the feed stream inlet of the second module.

6. The process of claim 5 wherein the brine stream comprises greater than or about 200 g/L NaCl and less than or about 10 g/L Na₂SO₄ and the pass stream from the nanofiltration system comprises less than or about 50 g/L NaCl and greater than or about 50 g/L Na₂SO₄.

7. The process of claim 6 wherein the brine stream comprises NaClO₃ or NaBrO₃.

8. The process of claim 6 wherein the volumetric flow rate ratio of the dilution stream to that of the brine stream is less than or about 12:70.

9. The process of claim 1 wherein the brine stream is spent brine stream from an electrolyser in a brine electrolysis plant.

10. A nanofiltration system for recovering brine and for removing sulfate impurity from a brine stream, the brine stream comprising an aqueous solution of NaCl, the system comprising a nanofiltration module, the module comprising a nanofiltration membrane for rejecting sulfate, an inlet for a feed stream, an outlet for a permeate stream which has permeated through the membrane, an outlet for a pass stream which has not permeated through the membrane, and a dilution stream connected to the feed stream upstream of the feed stream inlet of the module.

11. The nanofiltration system of claim 10 wherein the brine stream additionally comprises NaClO₃ or NaBrO₃.

12. The nanofiltration system of claim 10 wherein the dilution stream is water or diluted brine.

13. The nanofiltration system of claim 10 wherein the system is a multi-stage system comprising at least a first nanofiltration module and a second nanofiltration module in series, each module comprising a nanofiltration membrane for rejecting sulfate, a feed stream inlet, a permeate stream outlet, and a pass stream outlet, wherein the pass stream outlet of the first module is connected to the feed stream inlet of the second module.

14. The nanofiltration system of claim 13 wherein the dilution stream is introduced between the pass stream outlet of the first module and the feed stream inlet of the second module.

15. The nanofiltration system of claim 10 wherein the temperature of the dilution stream is substantially lower than that of the upstream brine stream and the system is absent a heat exchanger for cooling the upstream brine stream.

16. A brine electrolysis plant comprising an electrolyser and the nanofiltration system of claim 10 wherein the spent brine outlet of the electrolyser is connected to the feed stream inlet of the nanofiltration module.

17. A brine electrolysis plant comprising an electrolyser and the nanofiltration system of claim 10 wherein the brine inlet of the electrolyser is connected to the permeate stream outlet of the nanofiltration module.
